(19) United States
(12) Patent Application Publication
(10) Pub. No.: US 2006/0285964 A1
(43) Pub. Date: Dec. 21, 2006

(54) Component supplying device and a method of using the same

(75) Inventors: Hubert Francijn Maria Hoogers, BR Wintelre (NL); Roland Leo Bas Slegers, AK Vught (NL)

Correspondence Address: FOLEY AND LARDNER LLP;SUITE 500, 3000 K STREET NW, WASHINGTON, DC, 20007, US

(73) Assignee: Assembleon N.V.

(21) Appl. No.: 11/447,291

(22) Filed: Jun. 6, 2006

(30) Foreign Application Priority Data
Jun. 7, 2005 (NL) 1029206

(51) Int. Cl. B65G 1/133

(52) U.S. Cl. 414/749.1; 414/662

(57) ABSTRACT

A component supplying device is provided with a wafer holder, a first component pick-up device, and a second component pick-up device. The first and second component pick-up devices are movable along first and second guides, respectively. The first component pick-up device is movable between a pick-up position located near the wafer holder and a first supply position, while the second component pick-up device is movable between the pick-up position and a second supply position.

### CROSS-REFERENCE TO RELATED APPLICATIONS

This application claims priority to, and hereby incorporates by reference in its entirety, The Netherlands Patent Application No. 1029206, which was filed on Jun. 7, 2005.

### BACKGROUND

The invention relates to a component supplying device that is provided with a wafer holder and a component pick-up device that is movable along a guide. The component pick-up device is movable between a pick-up position located near the wafer holder and a supply position spaced therefrom by some distance. The invention also relates to a method of transporting components using such a component supplying device.

One such component supplying device is disclosed in U.S. Pat. No. 5,671,530 in which a wafer holder supports a wafer provided with components. The wafer is affixed to a film, which film is stretched in the wafer holder. As a result, the components on the wafer are spaced some distance apart, so that they can be picked-up from the film more easily. A component is picked-up from a pick-up position on the wafer by means of the component pick-up device that can be moved to and fro along a guide. Subsequently, the component is moved to a supply position by means of the component pick-up device. From the supply position, the component is placed at a desired position on a substrate by means of a conventional component pick-up and placement device. A disadvantage of the component supplying device disclosed in U.S. Pat. No. 5,671,530 is that the wafer-supported components can be supplied only to a single supply position.

What is needed, therefore, is an apparatus and a methodology that address at least one if not more of the deficiencies that afflict conventional practice, as previously described. For example, an object of the invention is to provide a component supplying device that can supply components to more than one supply position.

### SUMMARY

An embodiment of the present invention addresses a component supplying device. The component supplying device includes, among other possible things, a wafer holder, a first component pick-up device, and a second component pick-up device. The first and second component pick-up devices are configured to move along first and second guides, respectively. The guides are arranged at an angle relative to one another. The first component pick-up device is configured to move between a pick-up position and a first supply position while the second component pick-up device moves between the pick-up position and a second supply position. The components can subsequently be picked-up from the various supply positions by means of different component pick-up and placement devices and be, e.g., placed at one or more desired positions on a substrate.

The guides arranged at a greater than 0° angle relative to one another, thereby making it possible to pick-up components from the same pick-up position alternately with the first and the second component pick-up devices. Because the guides are arranged at an angle relative to one another, the component pick-up devices may be designed to be substantially identical or mirrored.

The components alternately picked-up by the first and second component pick-up devices can be supplied to different supply positions. As a result, the frequency at which the components deriving from the wafer are supplied is significantly greater than that disclosed in U.S. Pat. No. 5,671,530. Furthermore, it is also possible in this manner to accommodate more than one supply position from the space occupied by the wafer holder, thereby ensuring that optimum use is made of the available space.

In a further embodiment of the component supplying device, the wafer holder may extend substantially horizontally relative to the guides. As the wafer holder and hence the wafer supported by the wafer holder extend horizontally, the components supported by the wafer holder will be held on the wafer holder by the force of gravity, and will not be readily able to drop undesirably from the wafer. In this embodiment, the guides may extend horizontally above the wafer holder. Further, the supply positions may lie next to one another along a substantially horizontal line.

In another further embodiment of the component supplying device, in operation, the first component pick-up device may be located near the first supply position when the second component pick-up device is located near the pick-up position, and vice versa. As the component pick-up devices are alternately located near the supply positions and the pick-up position, the component pick-up devices will not substantially interfere with one another.

In another embodiment of the component supplying device, the wafer holder may be configured to move relative to the pick-up position. As a result, it is possible to keep the pick-up position at a fixed location relative to the supply positions, so that a component can each time be supplied to the pick-up position by moving the wafer holder and the wafer supported by the wafer holder.

Another embodiment of the present invention relates to a method. This method includes, among other possible steps: (a) picking-up, by means of a first component pick-up device, a first component at a pick-up position on a wafer supported by a wafer holder; (b) moving the first component pick-up device supporting the first component along a first guide to a first supply position, while moving a second component pick-up device along a second guide from a second supply position to the pick-up position; (c) picking-up, by means of the second component pick-up device, a second component at the pick-up position on the wafer; and (d) moving the second component pick-up device supporting the second component along the second guide to the second supply position, while moving the first component pick-up device along the first guide from the first supply position to the pick-up position. The first guide is not parallel to the second guide. The first and second guides extend between the first and second supply positions, respectively, and the pick-up position. As a result, it is possible to remove components from the wafer relatively quickly and to supply the components alternately to different supply positions.

In a further embodiment of this method, the method may also include the step of: moving the wafer holder to position the first component at the pick-up position before the step of picking-up, by means of the first component pick-up device, the first component. Additionally or alternatively, the method may also include the step of: moving the wafer holder to position the second component at the pick-up position before the step of picking-up, by means of the second component pick-up device, the second component.

These and other features, aspects, and advantages of the present invention will become more apparent from the following description, appended claims, and accompanying exemplary embodiments shown in the drawing.

### BRIEF DESCRIPTION OF THE DRAWING

FIG. 1 is a top plan view, which shows an embodiment of a component supplying device according to the present invention.

### DETAILED DESCRIPTION

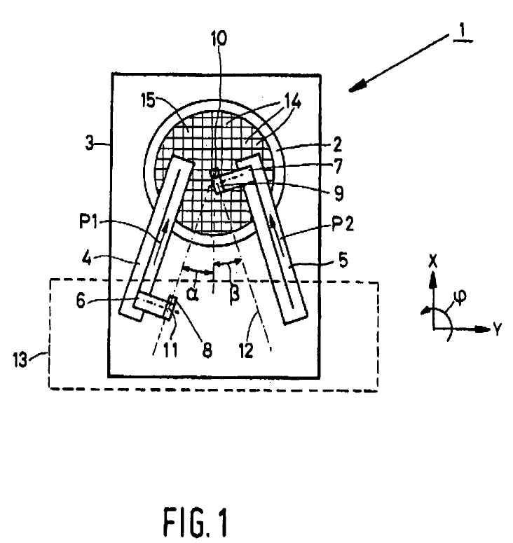

A presently preferred embodiment of the invention is illustrated in FIG. 1. An effort has been made to use the same, or like, reference numbers throughout the drawing to refer to the same or like parts.

FIG. 1 shows a component supplying device 1 according to the invention that is provided with a frame 3 supporting a wafer holder 2. The wafer holder 2, which extends in a horizontal plane, is movable by conventional means relative to the frame 3 in the directions indicated by the arrows X and Y (and in the directions opposite to arrows X and Y). The wafer holder 2 is also rotatable in the direction indicated by arrow φ (and in the direction opposite to arrow φ).

The frame 3 supports two guides 4, 5 which are each provided with a component pick-up device 6, 7 that is movable along the guides 4, 5. The guide 4 extends at an angle α relative to the Y axis, while the guide 5 extends at an angle β relative to the Y axis. In the case of the component supplying device 1 according to the shown embodiment, |α|=|β|.

The component pick-up devices 6, 7 are each provided with a nozzle 8, 9. The component pick-up device 6 can be moved in the direction indicated by the arrow P1 and in the opposite direction. The nozzle 8 is movable from a pick-up position 10 located near the center of the wafer holder 2 to a supply position 11 lying at some distance from the pick-up position 10. The nozzle 9 of the component pick-up device 7 can be moved in the direction indicated by arrow P2 and in the opposite direction between the pick-up position 10 and a supply position 12 lying at some distance from it. The supply positions 11, 12, which lie at some distance from one another, may lie along a line that extends substantially parallel to the X axis. The supply positions 11, 12 are located near part 13 of a conventional component pick-up and placement device.

The component supplying device 1 according to the invention works as follows. A wafer 15, which is supported by the wafer holder 2 and provided with components 14, is moved by conventional means in the X, Y, and φ directions (and in the opposite directions) until a component 14 to be picked-up is present at the pick-up position 10. One of the component pick-up devices 6, 7 is then moved to the pick-up position 10, so that the component 14 can be picked-up by means of the nozzle 8, 9. The picked-up component 14 is subsequently moved along the guide 4, 5 to the supply position 11, 12. While a component 14 is being picked-up from the pick-up position 10 by one of the component pick-up devices 6, 7, another component 14 may be supplied to one of the supply positions 11, 12 by the other component pick-up device 6, 7. While the component pick-up devices 6, 7 are in transit between the supply positions 11, 12 and the pick-up position 10, the wafer 15 may be moved, by the conventional means, to position another component 14 at the pick-up position 10. Each of the components 14 supplied to the supply positions 11, 12 may picked-up therefrom by one or more conventional component pick-up and placement devices and may be subsequently placed at desired positions on a substrate, for example.

Although the aforementioned describes embodiments of the invention, the invention is not so restricted. It will be apparent to those skilled in the art that various modifications and variations can be made to the disclosed embodiments of the present invention without departing from the scope or spirit of the invention.

By way of a first example, on a side of the wafer holder 2 facing away from the component pick-up devices 6, 7, a pin (not labeled) may be provided. The pin may upwardly press the components 14 to be picked-up. As the pick-up position 10 in the component supplying device 1 according to the present invention is the same for both component pick-up devices 6, 7, only one such a pin could be provided.

By way of a second example, the distance between the supply positions 11, 12 may be as small as possible, thereby enabling as many supply positions as possible to be accommodated by a corresponding number of component pick-up devices 6, 7, which may additionally be provided as part of the component supplying device.

By way of a third example, the wafer 15 may extend vertically, in a manner comparable to that shown in U.S. Pat. No. 5,671,530, to facilitate supplying a component from a relatively large wafer to the supply positions.

By way of a fourth example, the wafer 15 may extend horizontally, with several supply positions being provided in a space that is adjacent to the wafer 15 that is sized correspondingly to the wafer 15. Because the supply positions 11, 12 are alternately provided with components, the frequency at which components 14 are available is relatively high.

By way of a fifth example, the angles α and β may also differ from one another such that |α|≠|β|.

Accordingly, these other apparatuses and methods are fully within the scope of the claimed invention. Therefore, it should be understood that the apparatuses and methods described herein are illustrative only and are not limiting upon the scope of the invention, which is indicated by the following claims.

What is claimed is:

1. A component supplying device comprising:
a wafer holder;
a first component pick-up device that is configured to move along a first guide between a pick-up position located near the wafer holder and a first supply position spaced from the wafer holder; and
a second component pick-up device that is configured to move along a second guide between the pick-up position and a second supply position spaced from the wafer holder, while the first component pick-up device moves from the pick-up position to the first supply position,
wherein the first guide is not parallel to the second guide.

2. The component supplying device according to claim 1, wherein the wafer holder extends substantially horizontally relative to the guides.

3. The component supplying device according to claim 1, wherein, in operation, the first component pick-up device is located near the first supply position when the second component pick-up device is located near the pick-up position.

4. The component supplying device according to claim 3, wherein, in operation, the second component pick-up device is located near the second supply position when the first component pick-up device is located near the pick-up position.

5. The component supplying device according to claim 1, wherein, in operation, the second component pick-up device is located near the second supply position when the first component pick-up device is located near the pick-up position.

6. The component supplying device according to claim 1, wherein the wafer holder is configured to move relative to the pick-up position.

7. A method comprising the steps of:
picking-up, by means of a first component pick-up device, a first component at a pick-up position on a wafer supported by a wafer holder;
moving the first component pick-up device supporting the first component along a first guide to a first supply position, while moving a second component pick-up device along a second guide from a second supply position to the pick-up position;
picking-up, by means of the second component pick-up device, a second component at the pick-up position on the wafer; and
moving the second component pick-up device supporting the second component along the second guide to the second supply position, while moving the first component pick-up device along the first guide from the first supply position to the pick-up position,
wherein the first guide is not parallel to the second guide, and
wherein the first and second guides extend between the first and second supply positions, respectively, and the pick-up position.

8. The method according to claim 7, further comprising the step of:
moving the wafer holder to position the first component at the pick-up position before the step of picking-up, by means of the first component pick-up device, the first component.

9. The method according to claim 8, further comprising the step of:
moving the wafer holder to position the second component at the pick-up position before the step of picking-up, by means of the second component pick-up device, the second component.

10. The method according to claim 7, further comprising the step of:
moving the wafer holder to position the second component at the pick-up position before the step of picking-up, by means of the second component pick-up device, the second component.
